(19) United States
(12) Patent Application Publication
(10) Pub. No.: US 2026/0071331 A1
(43) Pub. Date: Mar. 12, 2026

(54) METHOD FOR PREPARING A METAL POWDER, AND APPLICATIONS

(71) Applicant: HYDRO-QUÉBEC, Montréal (CA)

(72) Inventors: Dominic LEBLANC, Bécancour (CA); Kamyab AMOUZEGAR, Mont-Royal (CA); Hugues LEVESQUE, Notre-Dame-du-Mont-Carmel (CA); Bernard TOUGAS, Saint-Maurice (CA)

(21) Appl. No.: 19/101,322

(22) PCT Filed: Aug. 4, 2023
(86) PCT No.: PCT/CA2023/051040

§ 371 Date: Feb. 5, 2025

(30) Foreign Application Priority Data
Aug. 5, 2022 (CA) 3169823

(51) Int. Cl. C23C 24/04; H01M 4/04; H01M 10/0525

(52) U.S. Cl. CPC C23C 24/04; H01M 4/0419; H01M 10/0525

(57) ABSTRACT

The invention provides a method for preparing a metal powder, in which an ultrasonic vibration is induced on a perforated membrane that is in contact with a liquid metal. The metal is a low-melting-point metal or an alloy based on such a metal and which has a low melting point. The resulting metal powder is deposited directly onto/into a deposition target.

### CROSS-REFERENCE TO RELATED APPLICATIONS

The present application claims the benefit of the Canadian patent application CA 3,169,823 filed on Aug. 5, 2022. The content of this Canadian application is incorporated herein in its entirety by way of reference.

### FIELD OF THE INVENTION

The present invention is related to a method for preparing a metal powder. The metal is, in particular, a low-melting-point metal (for example <450° C.). The method is, in particular, an ultrasonic method in which an ultrasonic vibration of a perforated membrane is induced, which membrane is in contact with the liquid metal. The method enables the on-site production of the metal powder at the time of its use, thereby overcoming the need to transport and/or store it. The method according to the invention, moreover, enables the spraying of the metal powder directly onto/into the deposition target.

### BACKGROUND OF THE INVENTION

Lithium metal in the form of powder contributes to the improvement in performance of lithium rechargeable batteries. Preparing lithium metal does however entail high costs. Many safety challenges are, moreover, associated with handling, transportation and storage. Indeed, lithium metal powder is hydro-reactive and pyrophoric.

Generally, preparing lithium metal powder is an empirical operation. In practice, the lithium metal is heated to 200° C. under a light oil film. It is then deposited in a preheated bowl (140 to 150° C.) containing a sufficient amount of oil to cause the metal to float. When the temperature of the metal drops, the lithium is agitated strongly and fine particles solidify. [1]

The company Livent (previously named FMC) has refined this technique in order to reduce the size of the particles of lithium powder obtained. The refined technique likewise comprises passivation of the surface of the lithium by means of a variety of reagents (CO₂, fluoride, wax, phosphorus, polymer). Livent holds a plurality of patents and patent applications relating to its technique: U.S. Pat. Nos. 5,567,474; 5,776,369; 5,976,403; US 2002/119373; U.S. Pat. No. 7,588,623; US 2008/283155; US 2011/300385; US 2017/149052; US 2019/097221. The lithium powder is named “Stabilized Lithium Metal Powder” (or SLMP) [2,3],

Companies such as Albemarle (US 2020/240020) and TDK (US 2016/099467) have likewise developed similar techniques.

In various other fields, technique for the atomization of liquids (organic or aqueous solvents) have been developed. For example, the method of inkjet printing is a contactless method in which very small drops of liquid ink are propelled by means of nozzles thanks to electrical intensity and forming points. The Drop On Demand method or DOD is generated each time that it is wanted. For the piezo-electric method, the ink reservoir is in contact with a piezo-electric crystal which will convert electric impulses into mechanical forces. It is the over-pressure induced by the piezo-electric element which allows the expulsion of the droplet (U.S. Pat. No. 3,683,212).

Based on the principle of the vibrating screen, many types of nebulizers have been developed for different applications: humidifiers, aromatherapy, distributors of medicinal products, injection of fuel (U.S. Pat. Nos. 4,533,082; 4,850,534; EP 0516565; U.S. Pat. Nos. 5,823,428; 4,153,201; 4,352,459; 4,655,393; 4,723,708; 4,978,067; US 2007/176017; WO 2008/058941; U.S. Pat. No. 9,981,090).

In the field of filtration of dust-containing gas or of the physical separation of nanomaterials in order to recover fine powder that is produced, certain technologies have been developed, including: the use of cyclones, of cartridge filters, of granular filters, of bubble columns and of electrostatic precipitators [4]. In particular, the latter is composed of a conducting wire connected to a high tension source, and surrounded by a metallic cylinder, wherein the cylinder serves both as a chimney for the dust-containing gas and as an electrode. The negative ions attach to the dust particles. The electrostatic force brings them towards the cylinder where they lose their charge and, becoming neutral particles, fall into the suitable containers (U.S. Pat. No. 895,729).

There is a need for methods of preparing lithium metal powder that are efficient and profitable. There is a need for methods for preparing lithium metal powder which allow the level of maintenance of the powder to be kept as low as possible.

There is also a need for the production of lithium metal powder, used as independent source of lithium during the manufacturing of the electrodes of lithium-ion rechargeable batteries and of lithium metal rechargeable batteries.

### SUMMARY OF THE INVENTION

The inventors have designed and implemented a method for preparing a metal powder. The metal is, in particular, a low-melting-point metal, for example below 450° C. Such metals include lithium, tin, gallium, indium, potassium, sodium, zinc, or an alloy of at least one of these metals with a melting point below 450° C. The method is, in particular, an ultrasonic method in which an ultrasonic vibration of a perforated membrane is induced, which membrane is in contact with the liquid metal. The method enables the on-site production of the metal powder at the time of its use, thereby overcoming the need to transport and/or store it.

According to one embodiment, the method of the invention enables the metal powder to be sprayed directly onto/into the deposition target.

According to another embodiment, the method enables the metal powder to be sprayed directly into a liquid to create a suspension.

According to one embodiment, the method of the invention provides an independent source of metal powder that is ready to be used, for example, in the manufacture of electrodes of batteries/rechargeable batteries (cathodes or anodes) or other components of batteries/rechargeable batteries when the metal powder is a lithium powder.

According to one embodiment, the invention provides an ultrasonic spraying device adapted for producing a metal powder. The device comprises: a reservoir that is adapted to receive a liquid metal and comprises a perforated membrane; and a sonotrode or a piezo-electric integrated into the reservoir. When an ultrasonic vibration of the perforated membrane is induced, the metal powder is produced and gathered directly onto/into a deposition target As a consequence, according to one aspect, the invention relates to:
(1). Method for preparing a metal powder, in which an ultrasonic vibration is induced on a perforated membrane that is in contact with a liquid metal.
(2). Method according to point (1) here above, in which the metal is a low-melting-point metal; wherein, preferably, the metal has a melting point lower than approximately 450° C.
(3). Method according to point (1) or point (2) here above, in which the metal is lithium, tin, gallium, indium, potassium, sodium, zinc, or an alloy of at least one of these having a melting point lower than approximately 450° C.; wherein, preferably, the metal is lithium or un alloy with a lithium base.
(4). Method according to any one of the points (1) through (3) here above, in which the resulting metal powder is in the form of a liquid aerosol, a solid aerosol, or an intermediary liquid-solid aerosol, or a combination of these forms.
(5). Method according to any one of the points (1) through (4) here above comprising, moreover, the deposition of the resulting metal powder directly onto/into a deposition target.
(6). Method according to point (5) here above, in which the deposition target is an enclosure comprising a liquid, thereby creating a suspension of metal powder in the liquid.
(7). Method according to point (5) here above, in which the deposition target is the surface of an anode, of a cathode, of a current collector, or any other component of a rechargeable battery.
(8). Method according to any one of the points (5) through (7) here above, in which the deposition comprises the application of a high voltage between an ultrasonic spraying device comprising the perforated membrane and the deposition target.
(9). Method according to point (5) here above, in which the metal powder is a lithium metal powder or a lithium-based alloy; and the deposition target is the surface of an anode, of a cathode, of a current collector, or any other component of a rechargeable battery.
(10). Method according to point (9) here above, in which a layer of a lithiophilic agent and/or in which a layer of a protective agent preventing undesirable reactions between the deposition target and the layer of lithium is applied on the surface of the target before deposition of the layer of lithium metal powder layer or of the alloy comprising the lithium; wherein, preferably, the lithiophilic agent comprises Cu, Zn, Sn, Si, Al, Ag, Sb, Bi, Cr, Fe, Mg, or an oxide of these, or a metal fluoride, or a combination of these; wherein, preferably, the protective agent is nickel, chrome, or cobalt.
(11). Method according to point (9) or point (10) here above, in which the lithium metal powder layer or of the lithium-based alloy is subsequently submitted to a thermal activation process and/or to a passivation process.
(12). Method according to point (5) here above, in which the metal powder is a lithium metal powder or a powder of a lithium alloy; and the deposition target is a container which contains an active electrode material, an aprotic solvent, a non-polar solvent, a hydrocarbon, a mineral oil, a polymer, or an additive, or a combination of these.
(13). Method according to any one of the points (1) through (8) here above, comprising, moreover, a step of mixing of the lithium metal powder obtained in an appropriate liquid; wherein, preferably, the liquid is an aprotic solvent, a non-polar solvent, a hydrocarbon, or a mineral oil, or a mixture of these.
(14). Method according to point (12) or point (13) here above, in which the liquid mixture containing the lithium metal powder is used in the manufacture of electrodes of rechargeable batteries (cathode or anode) or other rechargeable battery components.
(15). Method for preparing a metal powder, comprising the use of an ultrasonic spraying device comprising a perforated membrane, in which the perforated membrane is in contact with a liquid metal and the ultrasonic vibration of the perforated membrane is generated by means of a sonotrode immersed in the liquid metal or a piezo-electric producing the metal powder which is collected directly onto/into a deposition target.
(16). Method for preparing a metal powder, comprising the following steps:
(a) a liquid metal is introduced in a container associated with an ultrasonic spraying device, wherein the container comprises a perforated membrane, wherein the liquid metal is in contact with the perforated membrane;
(b) an ultrasonic vibration of the perforated membrane is induced by means of a sonotrode immersed in the liquid metal or by means of a piezo-electric, producing the metal powder; and
(c) the metal powder is collected on/in a deposition target.
(17). Method according to any one of the points (1) through (16) here above, being carried out on the manufacturing site of the electrodes of batteries/rechargeable batteries or other components of batteries/rechargeable batteries; wherein, preferably, the method is carried out in an enclosure under an inert atmosphere or under vacuum.
(18). Ultrasonic spraying device adapted for producing a metal powder, comprising: a reservoir adapted to receive a liquid metal and comprising a perforated membrane; and a sonotrode or a piezo-electric integrated in the reservoir in which,
when an ultrasonic vibration of the perforated membrane is induced, the metal powder is produced and collected directly onto/into a deposition target.
(19). Ultrasonic spraying device adapted for producing a metal powder, comprising: a reservoir adapted to receive a liquid metal and comprising a perforated membrane; and a sonotrode adapted to be immersed in the liquid metal in which,
when an ultrasonic vibration of the perforated membrane is induced, the metal powder is produced and collected directly onto/into a deposition target,
optionally the sonotrode is spaced apart from the perforated membrane,
optionally the sonotrode is in contact with the perforated membrane.
(20). Metal powder obtained by the method according to any one of the points (1) through (17); wherein, preferably, the particles of the powder have a diameter of between approximately 0.5 and 100 μm; wherein, preferably, the particles of the powder have a diameter of between approximately 1 and 50 μm.
(21). Liquid mixture comprising a lithium metal powder resulting from the method according to any one of the points (1) through (17); wherein, preferably, the liquid is an aprotic solvent, a non-polar solvent, a hydrocarbon, or a mineral oil, or a mixture of these; wherein, preferably, the mixture is a suspension comprising lithium particles.
(22). Electrode (cathode or anode) or any other component of batteries/rechargeable batteries, manufactured using a lithium metal powder resulting from the method according to any one of the points (1) through (17).
(23). Battery/rechargeable battery comprising an electrode (cathode or anode) or any other component of batteries/rechargeable batteries, manufactured using a lithium metal powder resulting from the method according to any one of the points (1) through (17).
(24). Installation for the manufacture of electrodes or other components of batteries/rechargeable batteries, incorporating the method according to any one of the points (1) through (17) here above, and in which the ultrasonic spraying device is fixed or mobile; wherein, preferably, the ultrasonic spraying device is linked to another device which moves according to the XYZ system.
(25). Installation for the manufacture of batteries/rechargeable batteries comprising electrodes or other components of batteries/rechargeable batteries, incorporating the method according to any one of the points (1) through (17) here above, and in which the ultrasonic spraying device is fixed or mobile; wherein, preferably, the ultrasonic spraying device is linked to another device which moves according to the XYZ system.
(26). Installation according to point (24) or point (25) here above, in which the deposition target is fixed or mobile; wherein, preferably, the deposition target is linked to a conveyor system or roll-to-roll type system.
(27). Manufacturing site for electrodes or other components of batteries/rechargeable batteries, incorporating the method according to any one of the points (1) through (17) here above.
(28). Manufacturing site for batteries/rechargeable batteries comprising electrodes or other components of batteries/rechargeable batteries, incorporating the method according to any one of the points (1) through (17).
(29). Manufacturing site for electrodes or other components of batteries/rechargeable batteries, comprising the installation according to any one of the points (24) through (26).
(30). Use of an ultrasonic spraying device for the preparation of a lithium metal powder.

Other subject matters, advantages, and features of the present invention will become more apparent from the following description of possible embodiments, provided exclusively by way of example, with reference to the following figures.

### BRIEF DESCRIPTION OF THE FIGURES

FIG. 1: Spherical lithium powder and its granulometric distribution according to the invention (Example 2).

FIG. 2: Perforated stainless steel membrane of the ultrasonic method.

FIG. 3: Spherical gallium powder according to the invention (Example 1).

FIG. 4: Schematic of the assembly that was used to produce the lithium powder (Example 2).

FIG. 5: Schematic of the assembly with the vibrating screen used for the Examples 3 and 4.

FIG. 6: Schematic of the method for spraying of the lithium at the perforated sonotrode.

FIG. 7: Spherical lithium powder and its granulometric distribution according to the invention (Example 3).

FIG. 8: Presentation of the dispersion of lithium powder in the anhydrous toluene.

### DESCRIPTION OF EMBODIMENTS OF THE INVENTION

Before the present invention will be further described, it is necessary to understand that the invention is not limited to the particular embodiments described here below, since variants of these embodiments may be created and remain within the scope of the attached claims. It is likewise necessary to understand that the terminology used is intended to describe particular embodiments and is not intended to be limiting. Instead, the scope of the present invention will be established by the attached claims.

In order to provide a clear and coherent understanding of the terms used in the present description, a certain number of definitions are provided here below. Moreover, as long as not otherwise indicated, all technical and scientific terms as used here have the same meaning as that commonly understood in the technical field to which the invention is related.

As used in this document, the term “metal powder” designates a metal in the form of a powder. It may be in the form of a liquid aerosol, a solid aerosol, or an intermediary liquid-solid aerosol. For example, the term “lithium metal powder” designates lithium metal in the form of powder. The particles that make up the powder may be of a generally spherical form. The particles may have a diameter in order of approximately 0.5-100 μm. In the text of the present application, the terms “powder” and “aerosol” are used in an interchangeable manner. In particular, the terms “lithium metal powder”and “lithium metal aerosol”are used in an interchangeable manner.

As used in this document, the following terms are used in an interchangeable manner: “sprayer,” “atomizer,” “screen vibrant,” “nebulizer.” Each of these terms designate an element by means of which the metal powder is produced. And, as indicated here above, the metal powder or metal in the form of powder may likewise be in the form of a liquid aerosol, a solid aerosol, or an intermediary liquid-solid aerosol.

The inventors have designed and implemented a method for preparing a metal powder. The metal is, in particular, a low-melting-point metal, for example below 450° C. Such metals include lithium, tin, gallium, indium, potassium, sodium, zinc, or an alloy of at least one of these metals with a melting point below 450° C. The method is, in particular, an ultrasonic method in which an ultrasonic vibration is induced of a perforated membrane that is in contact with the liquid metal. The method enables the on-site production of the metal powder at the time of its use, thereby overcoming the need to transport and/or store it. The inventors have likewise designed and created an ultrasonic spraying device adapted for producing a metal powder according to the invention.

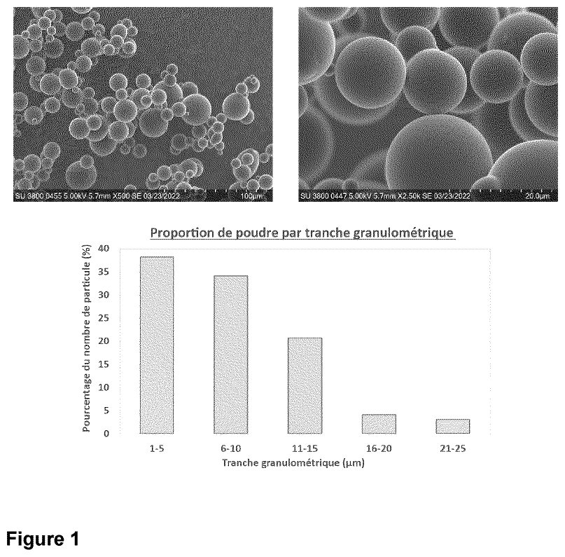

According to one embodiment, the invention relates to a product and atomization method of the lithium metal liquid for producing a liquid or solid aerosol in an environment that is inert, reactive or under vacuum (FIG. 1). The lithium metal liquid is sprayed, upon request, by means of an ultrasonic spraying device comprising a perforated membrane and which uses an ultrasonic method for forming spherical micro-droplets. The same exhibit a high electrochemical reactivity inasmuch as their surface is free of all contaminants (oxides, nitrides, carbonates, etc.).

According to one embodiment, the invention relates to a method for electrostatic recovery of liquid or solid droplets. The application of a high voltage between an ultrasonic spraying device and a target produces an intense electric field which directs the negatively (−) charged particles towards the positively (+) charged particles. The method thereby enables the recovery of fugitive particles and efficiently direct them to the deposition target. The particles can be captured in an electrostatic precipitator or sprayed directly on the surface of an electrode during its manufacture.

According to one embodiment of the invention, the collected lithium powder is transferred in a non-polar liquid solvent in order to form a liquid suspension liquid capable of being applied to an electrode during its manufacture.

According to one embodiment, the invention relates to one “independent” source of lithium that is able to be used in the manufacture of electrodes for lithium-ion (anode or cathode) or solid-state lithium rechargeable batteries. The lithium particles may be used in an electrode mixture (active material, solvent, polymer, additives), or sprayed directly, or in a suspension on the surface of a solid electrode. According to one aspect of the invention, the electrodes are then thermally activated to enable the diffusion of the lithium in the materials. According to another aspect, the electrodes are calendared by means of rollers which can be heating or non-heating. According to another aspect, a layer of a lithiophilic agent is applied on the surface of the solid electrode prior to the spraying with the lithium metal powder. The lithiophilic agent may comprise Cu, Zn, Sn, Si, Al, Ag, Sb, Bi, Cr, Fe, Mg, or their oxides, or a metal fluoride, or a combination of these. According to another aspect, depending on the nature of the electrode substrate, a protective layer may be applied on the electrode substrate prior to the application of the lithiophilic layer in order to prevent undesirable reactions between the electrode substrate and the lithium metal. According to another aspect, the passivation of the surface of the lithium particles is carried by means of a reactive atmosphere (for example: Ar/CO₂), or by using a liquid solvent containing a surface modification reagent.

According to one embodiment, the invention provides an “independent” source of lithium metal enabling the improvement of performance of the lithium and lithium-ion rechargeable batteries. The invention enables the low-cost manufacture of lithium metal powder, and enables the solution of a number of safety problems relating to storage, handling, and transportation of hazardous materials (hydro-reactive and pyrophoric powder), since it is produced on-site, on demand. According to one aspect, the lithium metal powder according to the invention has a smaller granulometric size than powders generally produced in the le field, and is therefore more interesting for certain applications. Moreover, since the lithium metal powder is incorporated immediately during the manufacture of the electrodes, the risks of electrochemical performance degradation over time are reduced.

The present invention relates to an ultrasonic method which uses an ultrasonic spraying device comprising a perforated membrane. Indeed, the inventors have discovered that it is possible to produce a lithium metal aerosol (solid or liquid) or lithium metal powder, by using such a device. In the method according to the invention, no compressed gas is needed to generate and transport the aerosol (compare thermal spray application). The manufactured lithium metal powder is fine, light, volatile, and fugitive.

Many applications of the invention are possible. Some of the applications are indicated here below.

According to one aspect, the method of the invention may be applied, in a similar manner to lithium metal, to all low-melting-point metals, for example, a metal having a melting point below 450° C. Such metals include, for example, lithium, tin, gallium, indium, potassium, sodium, zinc, or an alloy of at least one of these metals having a melting point below 450° C. According to another aspect, solid or liquid co-depositions can be carried out.

According to one aspect of the invention, the ultrasonic spraying device may be fixed or adapted to move according to an XYZ system. The deposition target may be fixed or movable on a conveyor or a roll-to-roll type system. In this way, a “lithium printer” is produced in a similar manner to the additive manufacturing technique.

According to one aspect of the invention, the temperature of the substrate and/or of its environment may be controlled in order to deposit a solid, liquid, or semi-solid-liquid powder.

According to one aspect of the invention, the solid powder may be transferred in an aprotic solvent, a hydrocarbon, a mineral oil, or a mixture of these. It is thereby possible to produce an independent source of lithium metal powder.

According to one aspect, after deposition of the lithium metal powder in an aprotic solvent, a hydrocarbon, a mineral oil, or a mixture of these, a passivation or a surface modification of the lithium powders can be carried out.

According to another aspect, an electrode mixture can be formed which can be spread on a current collector used in a lithium-ion rechargeable battery or in a lithium rechargeable battery.

According to one aspect of the invention, the product can be used as an independent source of lithium for the pre-lithiation of active materials (graphite, SiOₓ, Si, Sn, etc.) (see, for example, U.S. Pat. No. 6,706,447; US 2016/164073; US 2018/261829; US 2019/013513). According to another aspect, the lithium may be sprayed directly on an electrode or on a current collector or spread the powder in suspension in a volatile solvent [5-12].

According to one aspect of the invention, the product may be used in an electrode mixture and it can be applied by a coating on a current collector (US 2021/280909; US 2020/083518; US 2020/014033).

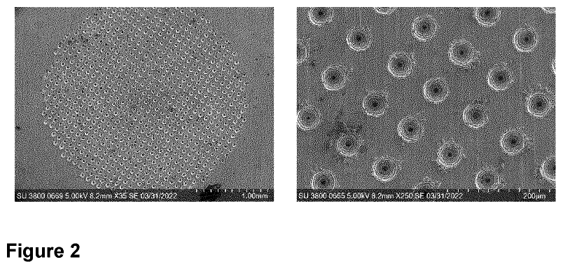

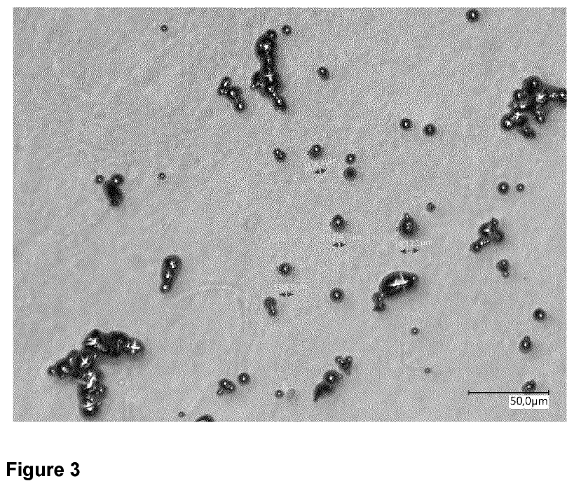

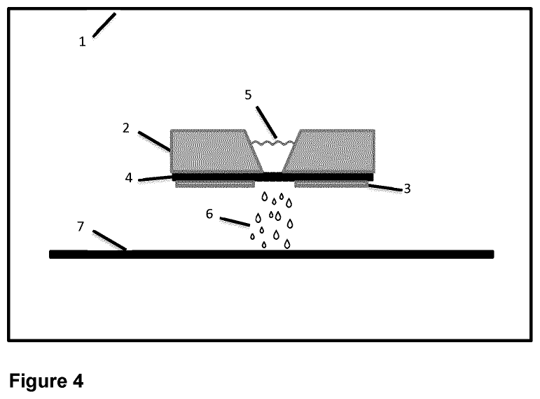

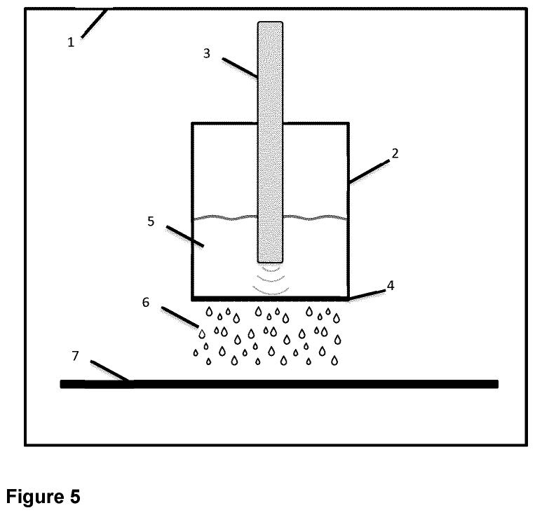

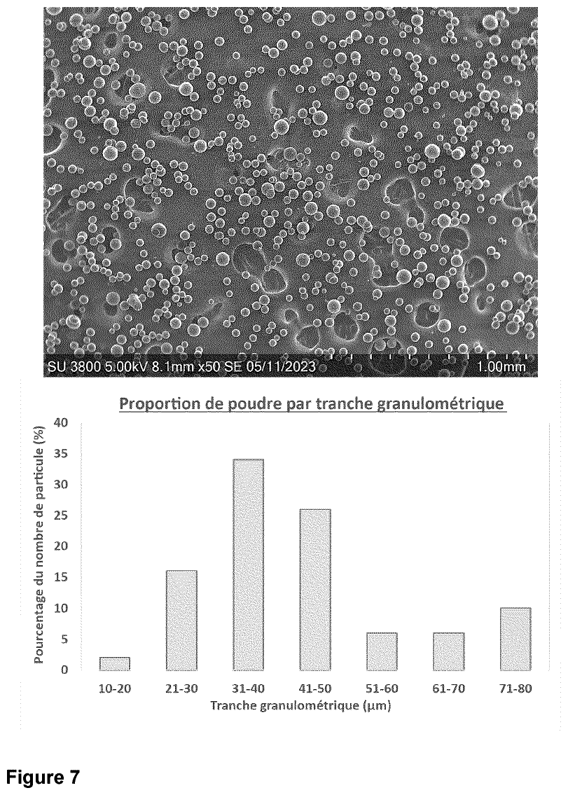

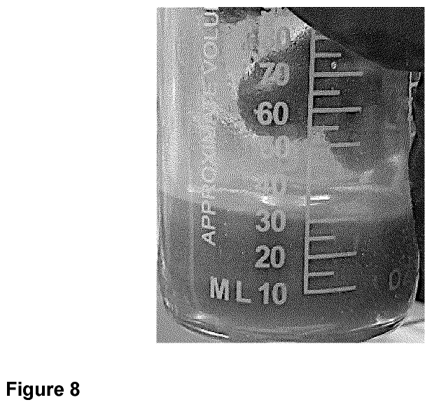

According to one aspect of the invention, the product or the method may be used to apply the lithium on a thin anode (U.S. application Ser. No. 16/458,074; U.S. Appl. No. 63/299,247). According to another aspect, a lithiophilic coating is applied beforehand and, if necessary, a protective layer depending on the nature of the substrate of the thin anode. This improves the quality of the deposition of lithium which infiltrates into the same. This technique is faster than the sputtering physical vapor deposition or thermal evaporation technique (EP 285476), does not require a vacuum process, and the temperature is lower (200 vs. 600° C.) (U.S. Pat. No. 5,522,955; WO 2020/210913). It is a good alternative to the method of deposition of lithium in a molten state (U.S. Pat. Nos. 5,169,446; 3,928,681; EP 0285476).
Example 1: An ultrasonic spraying device comprising a perforated membrane is assembled in order to implement the method according to the invention in relation to liquid gallium. The device consists of a ring-shaped piezoelectric element (lead zirconate titanate or PZT) supplied by a high-frequency sinusoidal voltage source (AV=108 V, f=110 kHz), a 50 μm-thick stainless steel membrane comprising 772 apertures having a diameter of approximately 7 μm spaced 90 μm apart (FIG. 2) and a reservoir of gallium liquid heated to 50° C. The device is installed in a fume hood in ambient air (20° C.). The piezoelectric element causes the perforated stainless steel membrane to vibrate at a frequency corresponding to ultrasonic waves, and provokes the ejection of liquid gallium through the 7 μm orifices. The sprays of liquid gallium break up into fine spherical droplets, forming a liquid aerosol in the air, which solidifies on contact with air at room temperature to form a powder with an average particle size directly proportional to the diameter of the orifices (approximately 10 μm). FIG. 3 shows the gallium powder obtained.
Example 2: The ultrasonic spraying device of Example 1 (FIG. 4) is used, however it is placed in a glovebox under a purified argon atmosphere (H₂O<0.1 ppm, O₂<0.1 ppm and N₂<0.1 ppm) (1). The argon temperature in the glove box is maintained at 20° C. This time, battery-grade lithium is used, which is melted (5) at 220° C. in the heated reservoir (2). The frame of the reservoir is made of 316L stainless steel, and its temperature is controlled by a heating cartridge and thermocouple. This system supplies the perforated membrane (4) with liquid lithium. This ultrasonic device with perforated membrane controls the temperature of the ultrasonic method at 220° C. A liquid lithium aerosol (6) is produced by means of the ultrasonic vibration provided by the piezo-electric or sonotrode (3), which liquid lithium aerosol solidifies rapidly on contact with argon at room temperature. The lithium powder is collected on the substrate (7). This test produced spherical particles with diameters between 0.5 and 25 μm, with an average of 7.5 μm. EDS analyses showed a surface free of any measurable contamination. FIG. 1 shows the lithium metal powder obtained.
Example 3: A device using an ultrasonic sonotrode was employed to generate the ultrasonic wave required to spray lithium liquid through a screen in order to produce lithium powders. FIG. 5 presents a schematic diagram of the assembly with a vibrating screen which was employed in the glovebox under purified argon atmosphere, just as in Example 2 (1). The sonotrode (3) used is made of titanium (Ti-6Al-4V) and has a sinusoidal oscillation frequency of 20 kHz. One hundred and fifty grams (150 g) of liquid lithium (5) are heated to 220° C. in a 316L stainless steel cylinder (2). A controller regulates the temperature of the resistive heating element by means of a thermocouple immersed in the liquid lithium (5). A woven stainless steel screen with apertures of approximately 25 μm (500 mesh) (4) is used to hold the lithium in the upper part of the assembly. The spraying chamber is likewise designed of 316L stainless steel. A strip (7) has been placed at the bottom of the chamber to collect the lithium particles/droplets (6). A 0.5 μm 316L stainless steel filter is installed on the spraying chamber to minimize the pressure differential with that of the glovebox. The sonotrode (3) is immersed in the liquid lithium and positioned at a short distance (approximately 3 mm) from the screen (4). The sonotrode (3) can be in contact with or spaced apart from the screen (4). FIG. 7 shows an electron micrograph of the spherical lithium particles produced by this test. The granulometric distribution presented shows that the particles have a diameter between about 10 and 80 um with an average of approximately 42 μm. The two operating modes below were tested.
   Example 3A: The sonotrode (3) is immersed in the lithium liquid and placed at a distance of approximately 3 mm from the screen (4). FIG. 7 shows an electron micrograph of the spherical lithium particles produced. The granulometric distribution presented shows that the particles have a diameter between 10 and 80 μm with an average of approximately 42 μm.
   Example 3B: The same device is used. The sonotrode (3) is in contact with the screen (4). A powder similar to that obtained in Example 3A is obtained.
Example 4: In order to carry out a coating, a spraying was carried out on a preheated strip (7). The test conditions are the same as for Example 3A. The particles were sprayed onto a 60 cm² copper strip (7) with a thickness of 5 μm. The latter is covered by a protective layer of electrolytic nickel (approximately 0.5 μm thick) and a lithiophilic tin layer (approximately 40 nm thick). The strip is located at a distance of approximately 65 mm from the screen (4). The latter was placed at the bottom of the spraying chamber (FIG. 5) and has been preheated to 230° C. by a heating element. The lithium powders produced interacted with the lithiophilic tin layer on the surface to form a lithium layer on the strip (7).
Example 5: The possibility of carrying out a liquid spraying on a strip similar to that used in Example 4 was also tested. Using the assembly and general conditions of Example 3 and Example 4, except that the distance between the vibrating screen (4) and the strip (7) was reduced to approximately 10 mm. In so doing, the droplets dropped directly onto the strip (7) before they had solidified. Each of the droplets wetted the surface of the strip (7) well. The liquid coating (of the spray type) has therefore been carried out.
Example 6: In order to demonstrate the feasibility of facilitating the transfer of lithium powder to the next stage of its use, a spraying was carried out directly in a solvent inert to lithium (toluene) to obtain a lithium powder suspension. The test was carried out in a glovebox under a purified argon atmosphere, using the same conditions and equipment as in Example 2, except that the spray chamber was a 250 ml beaker containing 30 mL of toluene that was previously dehydrated with a molecular screen to obtain a water concentration of less than 10 ppm. Following agitation, we obtain a dispersion of lithium powders in solvent (FIG. 8), which separates rapidly.
Example 7: A partial passivation of the lithium with polyoxyethylene distearate with a molecular weight of 200 (POE-200) was carried out. This enables a reduction of the reactivity of the powder during exposure in an anhydrous chamber and facilitates handling. The lithium particles were placed in a 1% wt. solution of POE-200 in toluene that was previously dehydrated with a molecular screen (H₂O<10 ppm). It was observed that the presence of POE allows for the lithium particles to be better dispersed in the solvent and to reduce the rate of liquid-solid phase separation. Subsequently, 4 mL of this solution as well as the original suspension (Example 6) were deposited in aluminum dishes and dried at 20° C. for 12 hours in a glovebox with purified argon (H₂O<0.1 ppm, O₂<0.1 ppm, and N₂<0.1 ppm). These two dishes were transferred to an anhydrous room (dew point −47° C.) and placed in a controlled-atmosphere chamber comprising an aqueous solution saturated in KOH to maintain the assembly atmosphere at a dew point nearing −15° C. The dishes were weighed over time to determine their mass gain. The unprotected lithium powder showed a weight gain of over 50% compared with the lithium powder treated with the POE solution. The mass gain is linked to the formation of lithium hydroxide. The presence of this compound was confirmed by means of an X-ray diffraction (XRD) analysis of the powders after exposure.

Referring to FIG. 5, a schematic representation of the ultrasonic device comprising a perforated vibrating membrane and using a sonotrode for the generation of ultrasonic vibrations which are transmitted to the membrane through the intermediary of the liquid. While contained in an enclosure with an inert, reactive, or partial vacuum atmosphere (1), the sonotrode (3) is immersed in the liquid lithium (or other metals or alloys) (5) contained in a container (2) comprising a perforated membrane (4). The assembly produces an aerosol/of droplets/of powders (6) which are collected on a substrate (7).

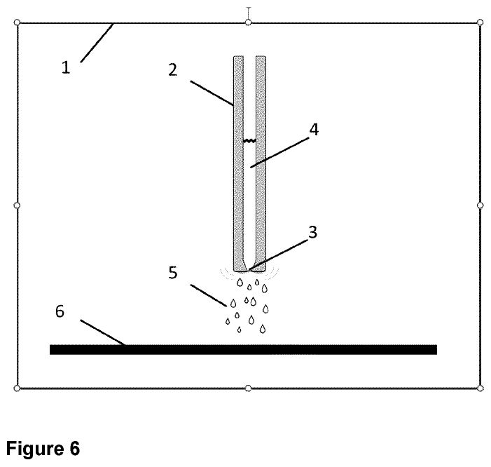

Referring to FIG. 6, a schematic representation of the ultrasonic device comprising a perforated vibrating membrane and using a sonotrode/piezoelectric to generate the ultrasonic vibration that pulverizes lithium (or other metals or alloys). Contained in an enclosure with an inert, reactive, or partial vacuum atmosphere (1), the end of the sonotrode (3) is pierced (4) and supplied with liquid lithium (5). The assembly produces an aerosol/of droplets/of powders (6) which are collected on a substrate (7).

Even if the present invention is described with reference to preferential embodiments, it is understood that the present description does not only refer to preferential embodiments and must not be considered to be limiting to the scope of the invention, which comprises various implementations as defined in the following claims. It is understood that several variations, modifications, uses, and adaptations may be added to the said implementations. The present invention is intended to cover such variations, modifications, uses, and adaptations, generally following the principles of the invention and including any variation of the present description which will become known or conventional in the field of the invention, and which can be applied to the above-mentioned elements, in agreement with the scope of the claims hereinafter.

The claims should not be limited in scope by the executions illustrated in the examples, but should be given the broadest interpretation consistent with the description as a whole.

The present description refers to a number of documents. The content of each of these documents is incorporated in its entirety in the present description by reference.

### REFERENCES

1. Meyer, J. H. C., Some practical aspects of handling lithium metal, in Handling and uses of the alkali metals. 1957, American Chemical Society, p. 9-15.
2. https://livent.com/applications-and-innovation/clear-lab/.
3. TDS, LECTRO® MAX POWDER 100, SLMP®, Livent.
4. Wildi, T. and G. Sybille, Électrotechnique. Fourth edition ed. 2005, p. 257.
5. Wang, Z., et al., Application of Stabilized Lithium Metal Powder (SLMP®) in graphite anode—A high efficient prelithiation method for lithium-ion batteries. Journal of Power Sources, 2014. 260: p. 57-61.
6. Fitch, B. B., et al., An Overview on Stabilized Lithium Metal Powder (SLMP), an Enabling Material for a New Generation of Li-Ion Batteries. ECS Transactions, 2007. 3(27): p. 15-22.
7. Zhao, H., et al., Toward Practical Application of Functional Conductive Polymer Binder for a High-Energy Lithium-Ion Battery Design. Nano Letters, 2014. 14(11): p. 6704-6710.
8. Ai, G., et al., Scalable process for application of stabilized lithium metal powder in Li-ion batteries. Journal of Power Sources, 2016. 309: p. 33-41.
9. Fan, K., et al., Application of stabilized lithium metal powder and hard carbon in anode of lithium-sulfur battery. Journal of Electroanalytical Chemistry, 2016. 760: p. 80-84.
10. Pan, Q., et al., Improved electrochemical performance of micro-sized SiO-based composite anode by prelithiation of stabilized lithium metal powder. Journal of Power Sources, 2017. 347: p. 170-177.
11. Huang, B., et al., Pre-Lithiating SIO Anodes for Lithium-Ion Batteries by a Simple, Effective, and Controllable Strategy Using Stabilized Lithium Metal Powder. ACS Sustainable Chemistry & Engineering, 2021. 9(2): p. 648-657.
12. Wang, F., et al., Construction of air-stable pre-lithiated SiOx anodes for next-generation high-energy-density lithium-ion batteries. Cell Reports Physical Science, 2022: p. 100872.

1. Method for preparing a metal powder, in which an ultrasonic vibration is induced on a perforated membrane that is in contact with a liquid metal.

2. Method according to claim 1, in which the metal is a low-melting-point metal; wherein, preferably, the metal has a melting point lower than approximately 450° C.

3. Method according to claim 1 or claim 2, in which the metal is lithium, tin, gallium, indium, potassium, sodium, zinc, or an alloy of at least one of these having a melting point lower than approximately 450° C.; wherein, preferably, the metal is lithium or un alloy with a lithium base.

4. Method according to any one of claims 1 through 3, in which the resulting metal powder is in the form of a liquid aerosol, a solid aerosol, or an intermediary liquid-solid aerosol, or a combination of these forms.

5. Method according to any one of claims 1 through 4, comprising, moreover, the deposition of the resulting metal powder directly onto/into a deposition target.

6. Method according to claim 5, in which the deposition target is an enclosure comprising a liquid, thereby creating a suspension of metal powder in the liquid.

7. Method according to claim 5, in which the deposition target is the surface of an anode, of a cathode, of a current collector, or any other component of a rechargeable battery.

8. Method according to any one of claims 5 through 7, in which the deposition comprises the application of a high voltage between an ultrasonic spraying device comprising the perforated membrane and the deposition target.

9. Method according to claim 5, in which the metal powder is a lithium metal powder or a lithium-based alloy; and the deposition target is the surface of an anode, of a cathode, of a current collector, or any other component of a rechargeable battery.

10. Method according to claim 9, in which a layer of a lithiophilic agent and/or in which a layer of a protective agent preventing undesirable reactions between the deposition target and the layer of lithium is applied on the surface of the target before deposition of the layer of lithium metal powder layer or of the alloy comprising the lithium; wherein, preferably, the lithiophilic agent comprises Cu, Zn, Sn, Si, Al, Ag, Sb, Bi, Cr, Fe, Mg, or an oxide of these, or a metal fluoride, or a combination of these; wherein, preferably, the protective agent is nickel, chrome, or cobalt.

11. Method according to claim 9 or claim 10, in which the lithium metal powder layer or of the lithium-based alloy is subsequently submitted to a thermal activation process and/or to a passivation process.

12. Method according to claim 5, in which the metal powder is a lithium metal powder or a powder of a lithium alloy; and the deposition target is a container which contains an active electrode material, an aprotic solvent, a non-polar solvent, a hydrocarbon, a mineral oil, a polymer, or an additive, or a combination of these.

13. Method according to any one of claims 1 through 8, comprising, moreover, a step of mixing of the lithium metal powder obtained in an appropriate liquid; wherein, preferably, the liquid is an aprotic solvent, a non-polar solvent, a hydrocarbon, or a mineral oil, or a mixture of these.

14. Method according to claim 12 or claim 13, in which the liquid mixture containing the lithium metal powder is used in the manufacture of electrodes of rechargeable batteries (cathode or anode) or other rechargeable battery components.

15. Method for preparing a metal powder, comprising the use of an ultrasonic spraying device comprising a perforated membrane, in which the perforated membrane is in contact with a liquid metal and the ultrasonic vibration of the perforated membrane is generated by means of a sonotrode immersed in the liquid metal or a piezo-electric producing the metal powder which is collected directly onto/into a deposition target.

16. Method for preparing a metal powder, comprising the following steps:
(a) a liquid metal is introduced in a container associated with an ultrasonic spraying device, wherein the container comprises a perforated membrane, wherein the liquid metal is in contact with the perforated membrane;
(b) an ultrasonic vibration of the perforated membrane is induced by means of a sonotrode immersed in the liquid metal or by means of a piezo-electric, producing the metal powder; and
(c) the metal powder is collected on/in a deposition target.

17. Method according to any one of claims 1 through 16, being carried out on the manufacturing site of the electrodes of batteries/rechargeable batteries or other components of batteries/rechargeable batteries; wherein, preferably, the method is carried out in an enclosure under an inert atmosphere or under vacuum.

18. Ultrasonic spraying device adapted for producing a metal powder, comprising: a reservoir adapted to receive a liquid metal and comprising a perforated membrane; and a sonotrode or a piezo-electric integrated in the reservoir in which,
when an ultrasonic vibration of the perforated membrane is induced, the metal powder is produced and collected directly onto/into a deposition target.

19. Ultrasonic spraying device adapted for producing a metal powder, comprising: a reservoir adapted to receive a liquid metal and comprising a perforated membrane; and a sonotrode adapted to be immersed in the liquid metal in which when,
an ultrasonic vibration of the perforated membrane is induced, the metal powder is produced and collected directly onto/into a deposition target,
optionally the sonotrode is spaced apart from the perforated membrane,
optionally the sonotrode is in contact with the perforated membrane.

20. Metal powder obtained by the method according to any one of the claims 1 through 17; wherein, preferably, the particles of the powder have a diameter of between approximately 0.5 and 100 μm; wherein, preferably, the particles of the powder have a diameter of between approximately 1 and 50 μm.

21. Liquid mixture comprising a lithium metal powder resulting from the method according to any one of the claims 1 through 17; wherein, preferably, the liquid is an aprotic solvent, a non-polar solvent, a hydrocarbon, or a mineral oil, or a mixture of these; wherein, preferably, the mixture is a suspension comprising lithium particles.

22. Electrode (cathode or anode) or any other component of batteries/rechargeable batteries, manufactured using a lithium metal powder resulting from the method according to any one of the claims 1 through 17.

23. Battery/rechargeable battery comprising an electrode (cathode or anode) or any other component of batteries/rechargeable batteries, manufactured using a lithium metal powder resulting from the method according to any one of the claims 1 through 17.

24. Installation for the manufacture of electrodes or other components of batteries/rechargeable batteries, incorporating the method according to any one of the claims 1 through 17, and in which the ultrasonic spraying device is fixed or mobile; wherein, preferably, the ultrasonic spraying device is linked to another device which moves according to the XYZ system.

25. Installation for the manufacture of batteries/rechargeable batteries comprising electrodes or other components of batteries/rechargeable batteries, incorporating the method according to any one of the claims 1 through 17, and in which the ultrasonic spraying device is fixed or mobile; wherein, preferably, the ultrasonic spraying device is linked to another device which moves according to the XYZ system.

26. Installation according to claim 24 or claim 25, in which the deposition target is fixed or mobile; wherein, preferably, the deposition target is linked to a conveyor system or roll-to-roll type system.

27. Manufacturing site for electrodes or other components of batteries/rechargeable batteries, incorporating the method according to any one of the claims 1 through 17.

28. Manufacturing site for batteries/rechargeable batteries comprising electrodes or other components of batteries/rechargeable batteries, incorporating the method according to any one of the claims 1 through 17.

29. Manufacturing site for electrodes or other components of batteries/rechargeable batteries, comprising the installation according to any one of the claims 24 through 26.

30. Use of an ultrasonic spraying device for the preparation of a lithium metal powder.
